(19) United States
(12) Patent Application Publication
(10) Pub. No.: US 2005/0043833 A1
(43) Pub. Date: Feb. 24, 2005

(54) Method for aiding the process of memorization

(76) Inventor: Jose E. R. Lopez, Sunnyvale, CA (US)

Correspondence Address: GROSS & ASSOCIATES, 8541 DOMINIQUE COURT, FAIR OAKS, CA, 95628, US

(21) Appl. No.: 10/956,462

(22) Filed: Sep. 30, 2004

Related U.S. Application Data
(63) Continuation-in-part of application No. 09/883,170, filed on Jun. 18, 2001.

(51) Int. Cl. G06F 17/00

(52) U.S. Cl. 700/94

(57) ABSTRACT

This invention provides methods, systems and devices that aid memorization. This invention allows the frequency at which a data file is viewed by a user to be based on a grading level for that data file, which is dynamically and selectively set by a user. Particularly, this invention includes the steps of obtaining data files each of which include data and a grade variable, viewing the data of the data files at a frequency based on the value of the grade variable of the data file being viewed, and manipulating the value of the grade variable of at least one of the data files.

### CROSS-REFERENCE TO RELATED APPLICATION

This is a continuation-in-part of patent application Ser. No. 09/883,170, filed Jun. 18, 2001, which is incorporated herein in its entirety by reference.

### BACKGROUND OF THE INVENTION

1. Field of the Invention

This invention relates to a method that aids a user in memorizing information desired by the user to be memorized.

2. Prior Art

Throughout history individuals worldwide have developed ways to assist them in the memorization process of information and data. Various methods, systems and devices exist in aiding a user to memorize a selected set of information or data. A user will select a method that aids the user's best mode of learning either visually or aurally. Most methods are in a written form, for example: the time consuming, repetitious writing out of facts, or the mess of making and carrying flash cards. Other methods require the inconvenience of having another person aurally quiz or test the user in the user's ability to recall the information. With the advent of microelectronics and microcomputers, digital recording devices have been employed to assist with the memorization of information. For the person that needs a combination of both repetition and aural input a deficiency exists with the traditional methods of memorization. There exists a need that can incorporate the methods of repetition and aural learning with modern technology that allows a user to benefit from these methods without the need for another person and can provide the convenience of portability. Another deficiency of modern methods, systems and devices is the inability of a user to selectively and dynamically evaluate and assign the repetition frequency of the information desired to be memorized. This invention fulfills these needs.

### SUMMARY OF THE INVENTION

It is the object of the present invention to provide a user an easy, quick and efficient method of memorization that allows the user to selectively and dynamically evaluate the data being memorized, thus aiding in the process of memorization. This invention provides a method of memorization that allows the user to assign grades based on the difficulty of the information desired to be memorized, thereby changing the number of repetitions for particular information or data sets that contain data files, which the user has learned.

This invention further provides a method of memorization that allows a user to view and review information for memorization to the satisfaction of the user.

In addition, this invention provides a method of memorization that allows the user to skip ahead or back to the desired information.

This invention further provides a memorization aid device that visually indicates the grading based on difficulty for each question number.

This invention also provides a method of memorization that tracks the user assigned grading variable for each data file and determines whether the data file should be repeated or skipped.

This invention further provides a method of memorization wherein the user assigned grading variables for all data files can be reset.

Continuing, this invention provides a memorization aid device that allows the user to import and export all recorded information into another memory receptacle such as a digital memory card, CD Rom, audio tape or the like.

This invention further provides a memorization aid device that visually indicates each data set and data file, text description and time left to play for each recording.

This invention also provides a memorization aid device that is portable and battery operated.

This invention further provides a memorization aid device that provides a jack for headphone use.

This invention also provides a memorization aid device that provides a microphone for sound recording.

Additionally, this invention provides a system for using said memorization aid device to the users maximum advantage.

This invention provides a method of aiding memorization that includes the steps of: acquiring at least one data set having data files, wherein each of the data files has a grading variable; viewing and manipulating the data files, wherein the manipulating of the data files includes changing the grading variable of at least one of the data files; and reviewing the data files based on the grading variables of the data files and the changed grading variable of the at least one of the data files in the manipulating step.

This invention yet further provides a method of operating a digital sound recorder including the steps of: obtaining sound data files; playing and grading at least one of the sound data files; designating a repetition rate of the sound data files based on the grading; and, replaying the sound data files based on the repetition rate.

Still further, this invention provides a system of aiding memorization comprising: a controller; an output device; a memory that stores data files each of which have an associated grading variable; a viewing circuit that under the control of the controller, reads the data file and outputs the data file to the output device at a frequency based on the grading variable of the data file being read; and, a manipulating circuit that under the control of the controller, changes the grading variable of at least one of the data files, wherein the manipulation circuit is executed by a user.

This invention also provides a method comprising the steps of: obtaining data files each of which have data and an associated a grade variable; viewing the data of the data files at a frequency based on the value of the grade variable of the data file being viewed; and, manipulating the value of the grade variable of at least one of the data files.

These and other features and advantages of this invention are described in, or are apparent from, the detailed description of various exemplary embodiments of the devices and methods according to this invention.

### BRIEF DESCRIPTION OF THE DRAWINGS

Various exemplary embodiments of this invention will be described in detail, with reference to the following figures:

FIG. 1 is a flow chart showing the sequence for the method embodying the invention;

FIG. 2 is a block diagram showing the structure of an Integrated Circuit embodying the invention;

FIG. 3 is a perspective view showing a sample of a physical embodiment of this invention;

FIG. 4 is a diagram showing the detail of the display on the exemplary physical embodiment of this invention;

FIG. 5 is a flow chart showing the sequence for a user to view data files;

FIG. 6 is a flow chart showing the sequence for a user to manipulate the grading variable on data files;

FIG. 7 is a flow chart showing the sequence for fast forwarding of data files;

FIG. 8 is a flow chart showing the sequence for rewinding of data files; and,

FIG. 9 is a flow chart showing the restoration process.

### DETAILED DESCRIPTION OF THE INVENTION

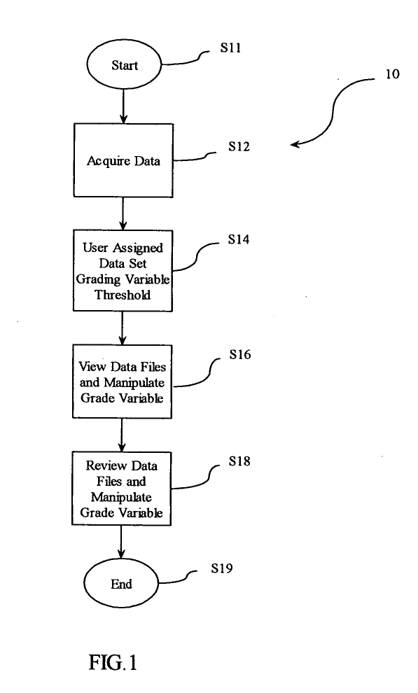

FIG. 1 illustrates a memorization method 10, which is an exemplary embodiment of a memorization method that is in accordance with this invention. In this invention the frequency of reviewing information, which includes a data set having data files, to be memorized by a user is dependent upon the user dynamically assigning a grading variable for each data file.

The basic steps of the method 10 consist of a Start step S11, an Acquire Data Set step S12, an User Assigned Data Set Grading variable threshold step S14, a View Data Files and Manipulate the Grade Variable step S16, a Review Data Files and Manipulate the Grade Variable step S18 and an End step S19. It is preferred that this memorization method 10 be executed via devices such as but not limited to hand held microcomputers, desktop or laptop computers, or other devices configured and or programmed to perform the method of memorization 10.

The method 10 begins at step S11 and continues to the Acquire Data step S12 wherein a data set is acquired. A data set is a group of information made of data files, which a user desires to memorize. Each data file has a data header, which includes a plurality of information specific to that data file, such as but not limited to a grading variable. All data files within a data set are initially given a default grading variable of 1 in the data header of each data file. Additionally, each data file is assigned in the data header a data file number when the data file is initially entered. The data files can be any type of data, including but not limited to digital, audio and/or video and can be either a linear or a nonlinear structure. The data sets may be store in any recording media such as but not limited to a portable recording device or any electronic memory cache.

At step S14, the user selects a data set grading variable threshold value for how often the user desires to review a selected data file. The grading variable determines how often the user reviews a data file as will be discussed further below. It should be appreciated that in other various exemplary embodiments the data set grading variable threshold is set at a default value of 3 and can be dynamically changed by the user to any other value desired by the user.

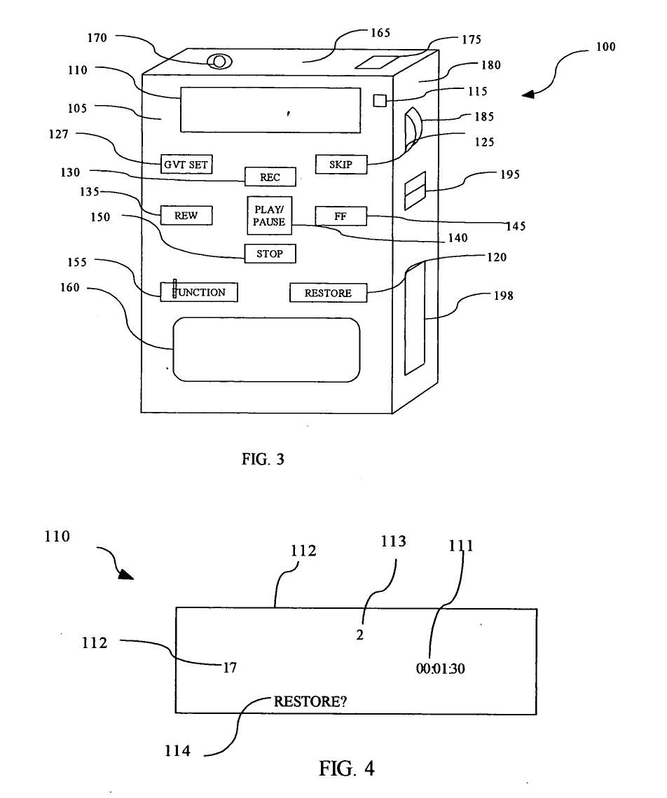

At step S16, the user will view the selected data set one data file at a time. Viewing the data file includes, but is not limited to for example the playing of an audio data file, video data file or a digital data file. The process of viewing data files will depend on the device used to execute the memorization method 10, some samples of various methods for viewing the data sets are but no limited to a presentation on a computer screen, or an audio playback for listening may be employed. During the viewing or playing of any of the data files the user can, if desired, selectively and dynamically change the grading variable in the data header of the particular data file being viewed. The user activates a grade variable increasing function to increase the value of the grade variable in the data header of a particular data file. The user can selectively change the grading variable more than one level if so desired. This grade variable increasing function can be any known circuitry link to an input device such that when the user executes the input device the grading variable in the data header will be altered such as for example, to be incremented by the integer 1. As set forth below, FIG. 3, for example, shows an exemplary embodiment of a hand device that incorporates such a grading variable input function in the form of a “skip” button. However, it should be appreciated that in other various exemplary embodiments the grading variable input function is implemented by a software application via the click of a mouse button or other input device common to electronic controllers, to allow the user to change the data header.

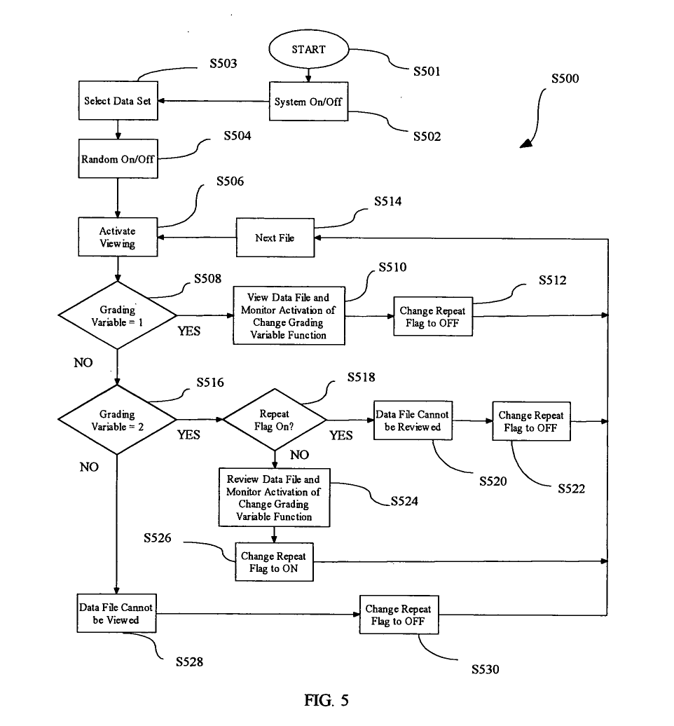

At step S18, the user can review the data files of a data set based on the grading variable assigned by the user in the View Data Files and Manipulate the Grade Variable step S16 previously. In one exemplary embodiment for example, if a data file with a data set has the default grading variable of 1 it will be reviewed every time by the user. While reviewing a data file the user can selectively and dynamically change the grading variable of the data file. The user can selectively change the grading variable more than one level if so desired. If the user has changed a data file's grading variable to 2, the data file will be reviewed every other time in the Review Data Files and Manipulate the Grade Variable step S18. Again, the user can selectively and dynamically change the grading variable of the data file while the data file is being reviewed. If a data file has a grading variable of 3, the data file will be reviewed every third time during the Review Data Files and Manipulate the Grade Variable step S118. Again, the user can selectively and dynamically change the grading variable of the data file while the data file is being reviewed. A data file within a data set will be reviewed until the grading variable has reached the data set grading variable threshold determined in the User Assigned Data Set Grading variable threshold step S14. This sequence will continue until all the data files in a data set have reached the grading variable threshold. An exemplary embodiment of steps S16 and S18 is set forth and described below with reference to FIG. 5. Furthermore, the user can sequence through the grading variables for a data file with the multiple execution of the grading variable change function. The user can do this so that the grading variable can revert back from the value of the grading variable threshold to a grading variable of 1. FIG. 5 is an exemplary embodiment with a grading variable threshold set to 3. In this exemplary embodiment, the user can sequence through the grading variables 1, 2, 3, and then back to 1 or 2 by multiple executions of the grading variable change function while a data file is being viewed or reviewed or right after the file has been viewed or reviewed.

It should be appreciated that the data files will be reviewed based on the grading. That is each data file will be reviewed at a certain repetition rate, which is based on the grading or grade variable assigned to the data file. Further, it is preferred that the repetition rate be inversely proportional to a grade level assigned to the file, such as for example as set forth above.

At any time during step S18 the user can activate a restore function that would reset the grading variable for an individual data file. This restore function can be any known circuitry link to an input device such that when the user executes the restore function, the grading variable in the data header will be altered such as for example, to be incremented by the integer 1. As set forth below, FIG. 3, for example, shows an exemplary embodiment of a hand device that incorporates such a restore function, which is executed by the pressing of the a “restore” button. However it should be appreciated that in other various exemplary embodiments the grading variable input function is implemented by a software application via the click of a mouse button or other input device common to electronic controllers, to allow the user to change the data header. It should be appreciated that in other various exemplary embodiments the restore function could be applied to all the data files in a data set at one time.

At this point the method 10 ends at step S19.

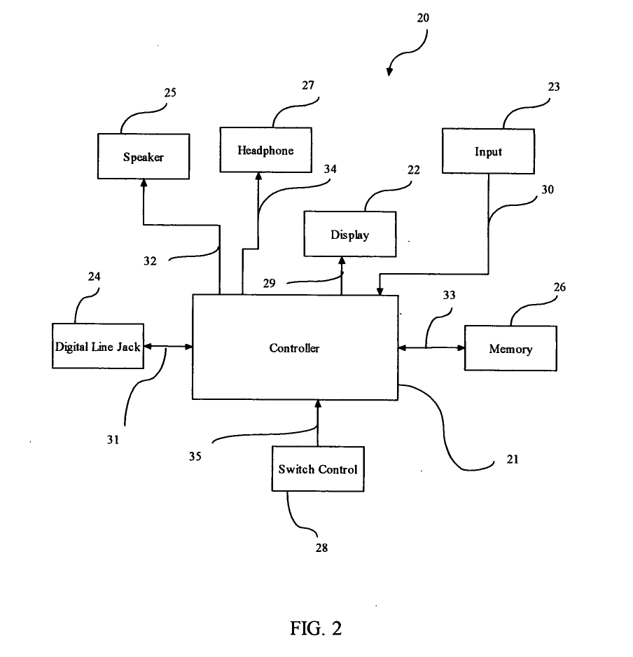

FIG. 2 is a schematic of a memorization system 20, which is an exemplary embodiment of a system for implementing the systems and methods according to this invention. The memorization system 20 includes a controller 21, a display 22, an input device 23, such as but not limited to a microphone, a digital line jack 24, a speaker 25, a memory module 26, a headphone jack 27, and a switch control panel 28.

The controller 21 includes a microprocessor and conducts the manipulation of data for the methods of this invention. The controller also includes various circuits, routines or managers to implement the methods and systems of this invention. The controller 21 further includes an input/output interface for communicating with the other components of the system 20 via links 29, 30, 31, 32, 33 and 34.

The display 22 provides an interface for the controller to communicate with the user. The display 22 can be a monitor or any other known or later developed device that is capable of displaying an electronic version of the output from the controller 21 for viewing or displaying information about any of the steps, processes and/or data contemplated by this invention. It should be appreciated that the display 22 is optional.

The input device 23 provides the user a means of inputting data to the memory 26, via the controller 21. The input 23 may be any combination of one or more standard input devices, such as a keyboard, a mouse, a joystick, a trackball, a touch pad, a touch button(s), a pen-based system, a microphone and associated voice recognition software, a sensor, an optical sensor or any other known or later developed device for inputting data and user commands to the controller 21.

The digital line jack 24 provides the user an alternative means to digitally input or output data to and from the memory 26, via the controller 21. It should be appreciated that the digital line jack 24 can be any known or later developed device for inputting or outputting digital data.

The speaker 25 and the headphone jack 27 provide the controller 21 a means to aurally communicate with the user.

The memory 26 provides the user a location to store data for use by the controller 21. The memory 26 can be implemented using any appropriate combination of alterable, non-alterable, volatile, or non-volatile memory or fixed memory. The alterable memory, whether volatile, or non-volatile, can be implemented using any one or more of static or dynamic RAM, a floppy disk and disk drive, a writable or rewritable optical disk and disk drive, a hard drive, flash memory or the like. Similarly, the non-alterable or fixed memory can be implemented using any one or more of ROM, PROM, EPROM, EEPROM, an optical ROM disk, such as a CD-ROM or DVD-ROM disk, and disk drive or the like.

The switch control panel 28 provides an interface for the user to manipulate the data within the controller 21. The switch control 28 includes but is not limited to any combination of one or more standard control devices, such as on, off, volume control, play, pause, stop, review, fast forward and rewind or any other known or later developed control device for manipulating the functions of the controller 21.

Any of the elements of the system can be housed or integrated with the controller 21. Alternatively, it should be appreciated that some or all of the other components of the system 20 do not have to be locally associated, integrated or housed with the controller 21. Rather, any of the elements of the system 20 can be connected to the controller 21 over any known or later developed connection devices, such as a modem, a local area network, a wide area network, and intranet, the Internet, or any other distributed processing network.

The links 29-34, can each be any known or later developed device or system for connecting the respective devices 22-28 to the controller 21, including a direct cable connection, a connection over a wide area network or a local area network, a connection over an intranet, a connection over the Internet, or a connection over any other distributed processing network or system. In general, the links can be any known or later developed connection systems or structure usable to connect the respective devices to the controller 21.

The system 20 can be implemented as software executing on a programmed general purpose computer, a special purpose computer, a controller or the like. Alternatively, the system 20 can be implemented as a routine embedded in a program as a resource residing on a server, or the like. The system 20 can also be implemented by physically incorporating it into a software and/or hardware system, such as the hardware and software system of a handheld recording/playing device.

It should also be understood that each of the circuits, routines or managers, which are operably configured to execute the methods of this invention and are implemented by the controller 21, can be implemented as portions of a suitably programmed general purpose computer. Alternatively, each of the circuits, routines or managers, can be implemented as physically distinct hardware circuits, routines or managers within an ASIC, or using a FPGA, a PDL, a PLA or a PAL, or using discrete logic elements or discrete circuit, routine or manager elements. The particular form each of the circuits, routines or managers will take as a design choice and will be obvious and predicable to those skilled in the art.

In operation, using the input device 23 or the digital line jack 24, the user can store data sets or data files into memory 26 under the control of the controller 21. It is preferred that the controller 21 assign a default grading variable of 1 to each data file as well as assign a data file number to each data file as the controller 21 places the data into the memory 26. Furthermore, it is preferred that the controller 21 set a repeat flag, as is described further herein, for each data file to off.

In operation, the switch control 28, under the control of the controller 21 allows the user to interact with data stored in the memory 26. Particularly, the user, via the switch control 28 will activate and/or execute various circuits, routines or managers that implement various exemplary embodiments of methods and systems of this invention. Further, it is preferred that the user be able to, via the switch control 28, select data sets and or data files, to view, manipulate, review, fast forward, rewind, restore, and change grading variables of the data files, as well as set the grading variable threshold of data sets in accordance with the methods and systems set forth herein and according to this invention.

According to this embodiment, the user has the ability to output data from the data sets and/or data files via the digital line jack 24, under the control of controller 21.

FIG. 3 is a perspective view of the embodiment of the device 100 that contains the components shown in FIG. 1 that execute the methods of this invention. The device 100 has a front panel 105, a top panel 165 and a right side panel 180. The front panel 105 has a display 110, a microphone 115, a restore button 120, a skip button 125, a data set grading variable threshold button 127, a record button 130, a rewind button 135, a play/pause button 140, a fast-forward button 145, a stop button 150, a function button 155, and a speaker 160. The top panel 165 has a headphone jack 170 and digital line jack 175. The right side panel 180 has a volume control 185, an on/off switch 195 and a battery compartment 198. The device as shown in FIG. 3 is rectangular in shape and made of hard plastic and fits in the users palm. It should be appreciated that in other various exemplary embodiments of this invention the device 100 could be of other shapes such as a molded plastic to conform to the fingers as it fits in the palm or other hand held shapes. It should be appreciated that the device 100 includes, but is not shown, a controller and memory, such as those shown and described above with reference to FIG. 2. Furthermore it should be appreciated that in other various exemplary embodiments of this invention the controller could be housed in other devices, for example a personal computer or other various computer hardware and software systems.

FIG. 4 is a enlarged, detailview of the front panel display 110 of the digital voice recorder 100. The display includes a time indicator 111. It is preferred that the time be an indicator of the viewing or playing length (in time) of a data file currently being played or viewed. Further, it is preferred that the time be displayed in hours, minutes and seconds for playing back the recorded data files. The display 110 further includes a file number indicator 112. The indicator 112 displays the data file order number for the data file currently being viewed or played. It should be appreciated that in other various exemplary embodiments, indicator 112 includes a description text of the data file. The display 111 also includes grading variable indicator 113. Indicator 113 displays the grading variable for the current data file being played or viewed. The display 111 further includes a status display 114. The status display 114 provides a visual indicator to the user to inform the user of the status of various functions that the system is performing or about to perform, and the status display also provides prompts for the user to execute various system functions. In this figure, the prompt to the user to confirm the desire to execute the Restore function is displayed as an example.

It is preferred that the data referenced in this invention be in a digital form. Data sets and/or data files can be implemented, for any of the embodiments of this invention, in a variety of ways that will be readily recognized and understood by one skilled in the art. For example, in some exemplary embodiments, such as the device shown and described above with reference to FIG. 3, the data sets and/or data files are inputted via microphone as a means of recording sound. In other exemplary embodiments, data sets and/or data files are inputted via digitally pre-recorded questions and answers from devices such as, but not limited to, a computer. In the exemplary embodiment shown in FIG. 3, the user dictates a question, creates a few seconds of pause in the recording then dictates an answer. During playback the user plays the question then pushes a pause button. During the user controlled pause the user tries to remember the answer as a means to quiz his memory. The user then continues the play so as to hear the answer and verify if he was correct. At this moment the user can then decide to assign a grading variable that is appropriate to the difficulty of the question. The grading variable automatically controls the frequency of repetition of that data set for subsequent sessions.

FIG. 5 depicts an alternate exemplary embodiment of the memorization method 10 with a data set grading variable threshold of 3 and how a user can view or play the data sets desired to be memorized. It should be appreciated that the grading variable threshold for the data set is a variable that can for example be stored in the memory 26 in the exemplary embodiment for the system 20 described above with reference to FIG. 2. It should be appreciated that in other various exemplary embodiments the grading variable threshold could be greater or less than 3 as desired by the user. The data sets contain data files. Each data file has a data header, which includes a plurality of information specific to that data file, such as but not limited to a grading variable, data file number, and a repeat flag. The repeat flag is preferred to be a switch type flag, such as being either “on” or “off”, or being either a “0” or a “1.” All data files within a data set are initially given a default grading variable of 1 in the data header of each data file. Each data file in sequentially numbered in the data header as the user inputs the data set. The method S500 begins at Start step S501. The user initiates the sequence by executing a System On/Off S502 step. In this step, the user, for example, would simply execute a program operably configured to execute this method 500 or turn on a device having a process operably configured with circuits or programs to execute this method 500, such as the device described above with reference to FIG. 3. The user then selects the desired data set in the Select Data Set S503 step. The user is given the option of either reviewing the data set in the sequence inputted or randomly by selecting a Random On/Off function at step S504. The random on/off function is preferably any known or later developed method or hardware that enables a random number to be generated. This number, if the function is selected by the user, by for example the function button 155 shown above in FIG. 3, will present all the data files to be viewed randomly and not in sequential order by their data file number.

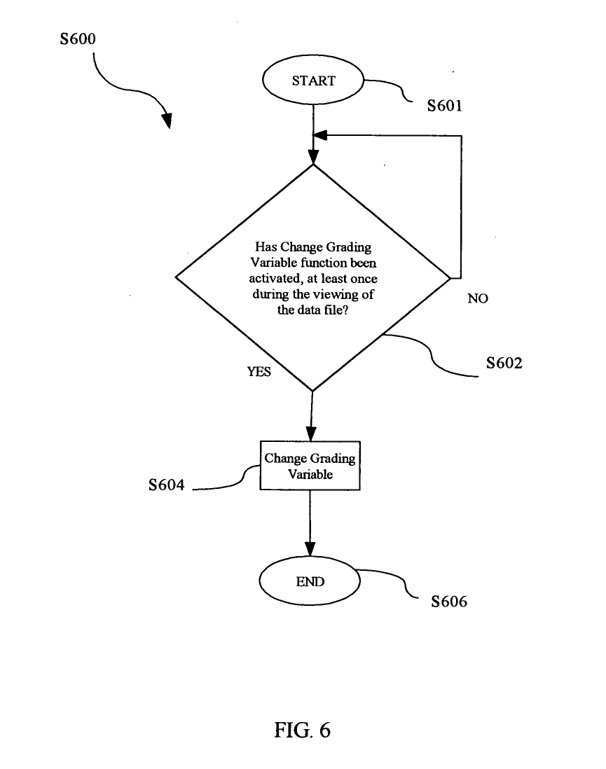

The next step is for the user to execute the activate viewing at step S506. The activation is accomplished by, for example pressing the Play/Pause button in foregoing exemplary physical embodiment represented in FIG. 3. It should be appreciated that the activation of the viewing may also be automatic if there was a data being previously viewed at step S506 step. At step S508, the first or next data file to be viewed is then checked to determine whether the grading variable in its header is equal to 1. If the grading variable for that file is equal to 1, then the file is played at the view file and monitor activation of change grading variable function step S510. The data file can be viewed by the user in media formats common with current technology such as but not limited to audio playback or data displayed on a computer screen. It should be appreciated that viewing in this process will be dictated by the type of data file. For example, if the data file is simply an audio file, then the view file feature will encompass playing the audio data file such that the user can hear the output. It should be appreciated that the playing can be accomplished with any conventional audio playback devices and means as well as the exemplary embodiment of the handheld device made in accordance with this invention described above with reference to FIGS. 3 and 4. The process also monitors the manipulation of the grading variable in step S510. This monitoring occurs during the entire viewing of the file. An exemplary embodiment of this monitoring process is set forth and described in below with reference to FIG. 6.

Following step S510, the repeat flag variable in the header of the data file is turned off at step S512 and the process flows to the Next File step S514, wherein the next data file in the data set is selected. It should be appreciated that if random viewing is turned off in step S504, the next file in sequential file number order will be selected. If the random viewing is turned on in step S504, then the random number generator developed in that step will dictate the order of the next file selected in step S514, as will be understood by those skilled in the art.

If in step S508 the answer was no, then the process proceeds to step S516, wherein the grading variable in the data header of the data file is checked to determine if it equals 2. If the data file does have a grading variable of 2 then the data file will be checked to see if the repeat flag, in the data header, is on at step S518. If the repeat flag is on, then the process proceeds to step S520, wherein the process will not allow the data file to be viewed.

Following step S520 the file's repeat flag will be turned off at step S522. From here the sequence returns to step 514 and the user starts the sequence for the next data file, as discussed above.

If in step S518 the repeat flag for the data file is determined to be off, then the data file will be reviewed for the user as well as monitored for activation of the Change Grading Variable Function at step S524. The reviewing and monitoring is accomplished in the same manner as discussed above for step S510.

After the data file is reviewed and monitored at step S524, the repeat flag variable of the data file is changed to On at step 526. The process then returns to step S514 and the sequence is repeated for the next file.

If in step S516 it was determined that the grading variable for the data file is not equal to 2, then the process will not view the data file as indicated at step S528. The process proceeds to step S530, wherein repeat flag variable for the data file is changed to Off. The process then returns to step S514, wherein the next file is selected as discussed above.

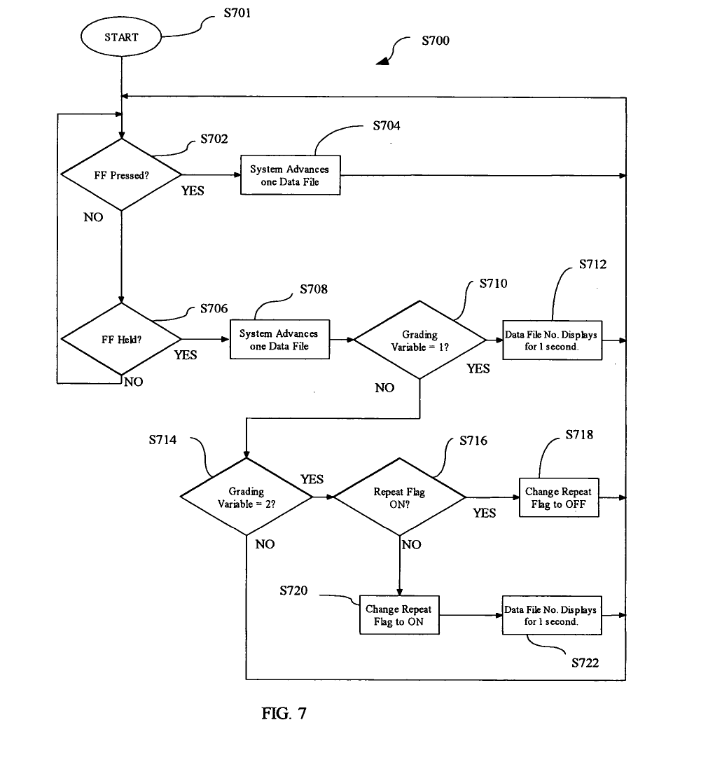

This process 500 will continue for this embodiment until the user has changed all the grading variables for each data file in the selected data set to value equal to 3. At any time in the process the user can activate a fast forward, a rewind, and/or a restore function. Exemplary embodiments of these functions are set for the below and described with reference to FIGS. 7, 8 and 9, respectively.

FIG. 6 illustrates a method 600, which is an exemplary embodiment of a method of monitoring the activation of change grading variable function in accordance with this invention. Method 600 monitors whether the user has, at any time during the viewing or reviewing of a data file, changed the grading variable of the data file. Method 600 is a method that can be utilized in steps 510 and S524 of foregoing embodiment.

Method 600 begins at step S601 and proceeds to step S602, wherein it is determined whether the user has activated a change grading variable function during the viewing of the data file. The activation of the change grading variable function by, for example the use of the skip button 125 referenced in the exemplary embodiment of FIG. 3. However, it should be appreciated that in other various exemplary embodiments the change grading variable function is implemented by a software application via the click of a mouse button or other input device common to electronic controllers, to allow the user to change the data header. It should be appreciated that in other various exemplary embodiments the change of a grading variable function could be accomplished by other methods. If yes, the process proceeds to step S604, wherein the grading variable is changed in accordance with the number of times that the user currently activated the change grading variable function and more particularly in accordance with the following: Grading Variable (GV)=current Grading Variable+Number of times change grading variable function activated. For example in connection with the device described and referenced above in connection with FIG. 3, if the user pressed the skip button one time for the current file, the grading variable will increase by one, if the user pressed the skip button twice, the grading variable will increase by two, and so on. It will be appreciated that the user may actually activate the change grading variable function enough times for the current file, such that the grading variable for that file actually rolls over once it reaches the preset grading variable threshold, described above. So for example, if a data file has a current grading variable of 2 and the user activates the change grading variable twice, either during or right after the data file is viewed, the grading variable will change from 2 to 3 and then back to 1. In this manner, the user is actually restoring this individual file.

The process ends at step S606. It should be appreciated that the user may express his/her desire to change the grading variable in a variety of ways, such as for example, but not limited to, the utilization of the switch control 28 described above with reference to FIG. 2, or more particularly the skip button 125 described above in FIG. 3. It should also be appreciated that in other various exemplary embodiments, the input by the user may be a variety of other means, such as for example, oral commands. Thus, the determination at step S602 is dependent upon a user's input to increase the grading variable.

If at step S602, the determination was negative, the process continues to monitor by returning to step S602. The data file will continue to be monitored until the file is finished being viewed or until another function is activated such as fast forward, rewind and/or restore functions, as discussed below.

FIG. 7 is a flowchart that illustrates a method 700, which is an exemplary embodiment of a fast forward function that may be utilized with the memorization method 10 and the method 500. Method 700 is an embodiment wherein the data set grading variable threshold is set to 3. Method 700 provides the circuit logic for the fast forward function so that the data files can be advanced based on the grading variable at the desire of the user. Method 700 is a method that is preferably running the entire time the user is using a system that is implementing any of the above methods 10 and 500. It is assumed in this exemplary embodiment that several data files have been viewed and the user has assigned a grading variable to some of the data files.

Method 700 starts at step S701 and proceeds to step S702, wherein it is determined whether the user has activated and released (or deactivated) a fast forward function. It should be appreciated that the user may express his/her desire to activate the fast forward function in a variety of ways, such as for example, but not limited to, the utilization of the switch control 28 described above or more particularly by pressing once the fast forward button 145 described above. It should also be appreciated that in other various exemplary embodiments, the input by the user may be a variety of other means, such as for example, oral commands. Thus the determination at step S702 is dependent upon a user's input to activate once the fast forward function:

If the determination at step S702 is positive, then the process proceeds to step S704, wherein the system will advance up to the next data file. The purpose of this step is to provide the user a means to quickly move forward one data file at a time and provide further monitoring of whether the user has activated a fast forward function once.

If in step S702 it is determined that the user has either not activated the fast forward function or has not activated and immediately deactivated the fast forward function, the process proceeds to step S706.

At step S706 it is determined whether the user has activated the fast forward function and held the activation thereof. For example, in the exemplary embodiment depicted in FIG. 3, the fast forward button 145 is held by the user. If the determination is positive, the process proceeds to step S708, wherein the system will advance up to the next data file. The purpose of this step is to provide the user a means to quickly move forward more than one data file at a time and provide further monitoring of whether the user has activated a fast forward function once.

The process proceeds to step S710, wherein it is determined if the grading variable in the data header of the current data file is equal to 1. If this determination is affirmative, then the process proceeds to step S712, wherein the data file number is outputted to the user. It is preferred that the output of the data file number be displayed to the user and further that the number be displayed for a predefined duration, such as but not limited to 1 second. A data file number can be displayed in such a way but is not limited to a numerical display on digital display panel as shown in FIG. 4, for example. The process then proceeds back to step S702 for further monitoring.

If the determination at step S710 is negative, an additional determination is made at step S714, wherein the method 700 checks to see if the grading variable of the current data file is equal to 2. If so, the process proceeds to step S716, wherein it is determined whether the repeat flag variable of the data file set to On. If positive, the process proceeds to step S718, wherein the repeat flag of the data file is change to Off The process then proceeds back to step S702 for further monitoring.

If at step S716, the determination is negative, the process proceeds to step S720, wherein the repeat flag variable is changed to On. The process then proceeds to step S722, wherein data file number is outputted to the user, similar to step S712 described above. The process then proceeds back to step S702 for further monitoring.

If at step S714, the determination is negative, the process proceeds to step S702 for further monitoring.

If at step S706 the determination is negative, the process proceeds to step S702 for further monitoring.

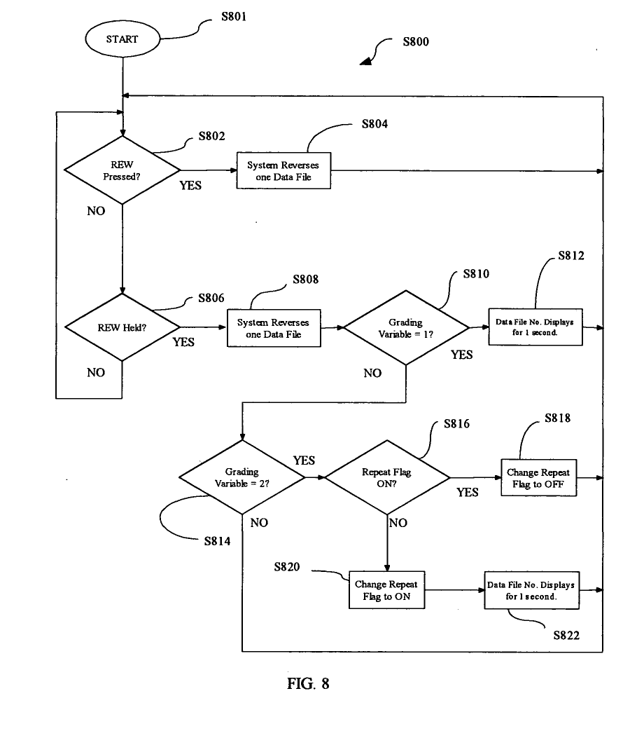

FIG. 8 is a flowchart that illustrates a method 800, which is an exemplary embodiment of a rewind function that may be utilized with the memorization method 10 and the method 500. Method 800 is an embodiment wherein the data set grading variable threshold is set to 3. Method 800 provides the circuit logic for the rewind function so that the data files can be advanced based on the grading variable at the desire of the user. Method 800 is a method that is preferably running the entire time the user is using a system that is implementing any of the above methods 10 and 500.

Method 800 starts at step S801 and proceeds to step S802, wherein it is determined whether the user has activated and released (or deactivated) a rewind function. It should be appreciated that the user may express his/her desire to activate the rewind function in a variety of ways, such as for example, but not limited to, the utilization of the switch control 28 described above or more particularly by pressing once the rewind button 135 described above. It should also be appreciated that in other various exemplary embodiments, the input by the user may be a variety of other means, such as for example, oral commands. Thus, the determination at step S802 is dependent upon a user's input to activate once the rewind function.

If the determination at step S802 is positive, then the process proceeds to step S804, wherein the system will reverse back to the previous data file. The purpose of this step is to provide the user a means to quickly move backwards one data file at a time and provide further monitoring of whether the user has activated a rewind function once.

If in step S802 it is determined that the user has either not activated the rewind function or has not activated and immediately deactivated the rewind function, the process proceeds to step S806.

At step S806 it is determined whether the user has activated the rewind function and held the activation thereof. For example, in the exemplary embodiment depicted in FIG. 3, the rewind button 145 is held by the user. If the determination is positive, the process proceeds to step S808, wherein the system will reverse back to the previous data file. The purpose of this step is to provide the user a means to quickly move back more than one data file at a time and provide further monitoring of whether the user has activated a rewind function once.

The process proceeds to step S810, wherein it is determined if the grading variable in the data header of the current data file is equal to 1. If this determination is affirmative, then the process proceeds to step S812, wherein the data file number is outputted to the user. It is preferred that the output of the data file number be displayed to the user and further that the number be displayed for a predefined duration, such as but not limited to 1 second. A data file number can be displayed in such a way but is not limited to a numerical display on digital display panel as shown in FIG. 4, for example. The process then proceeds back to step S802 for further monitoring.

If the determination at step S810 is negative, an additional determination is made at step S814, wherein the method 800 checks to see if the grading variable of the current data file is equal to 2. If so, the process proceeds to step S816, wherein it is determined whether the repeat flag variable of the data file set to On. If positive, the process proceeds to step S818, wherein the repeat flag of the data file is change to Off. The process then proceeds back to step S802 for further monitoring.

If at step S816, the determination is negative, the process proceeds to step S820, wherein the repeat flag variable is changed to On. The process then proceeds to step S822, wherein data file number is outputted to the user, similar to step S812 described above. The process then proceeds back to step S802 for further monitoring.

If at step S814, the determination is negative, the process proceeds to step S802 for further monitoring.

If at step S806 the determination is negative, the process proceeds to step S802 for further monitoring.

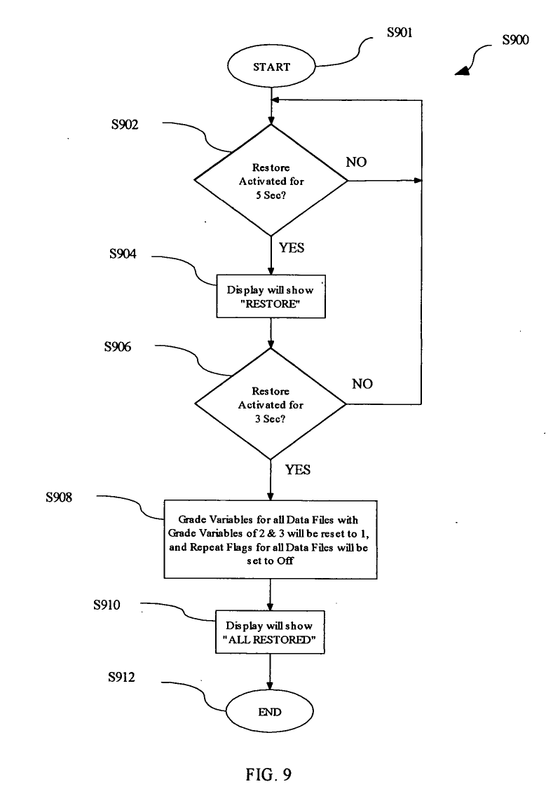

FIG. 9 is a flowchart that illustrates a method 900, which is an exemplary embodiment of a restore function that may be utilized with the memorization method 10 and the method 500. Method 900 provides the circuit logic for the restore function so that the data files can be restored at the desire of the user. Being restored means changing the grading variable to 1 and resetting the repeat flag to Off so that the file will not be skipped during the next viewing, fast forward and/or rewind. Method 900 is a method that is preferably running the entire time the user is using a system that is implementing any of the above methods 10 and 500. It is assumed in this exemplary embodiment that several data files have been viewed and the user has assigned a grading variable to some of the data files

Method 900 begins at step S901 and proceeds to step S902, wherein it is determined whether the user has activated and held active a restore function for a predefined duration. The predefined duration is preferred to be about 5 seconds. It should be appreciated that the user may express his/her desire to activate the restore function in a variety of ways, such as for example, but not limited to, the utilization of the switch control 28 described above or more particularly by pressing once the restore button 120 described above. It should also be appreciated that in other various exemplary embodiments, the input by the user may be a variety of other means, such as for example, oral commands. Thus, the determination at step S902 is dependent upon a user's input to activate once the rewind function.

If the determination at step S902 is negative, the process proceeds back to step S902 for further monitoring.

If the determination at step S902 is affirmative, the process proceeds to step S904, wherein, the process will output to the user a prompt to confirm that the user desires to restore the data file. It is preferred that the output of the prompt be displayed to the user and further that the prompt be displayed for a predefined duration, such as but not limited to 10 seconds. The prompt can be displayed in such a way but is not limited to a question, such as “RESTORE”, displayed on the digital display panel as shown in FIG. 4, for example.

The process then proceeds to step S906, wherein it is determined whether the user has activated and held active the restore function for a predefined duration, similar to step S902. The predefined duration is preferred to be about 3 seconds. If the determination at step S906 is negative, the process proceeds back to step S902 for further monitoring.

If the determination at step S906 is affirmative, the process proceeds to step S908, wherein all of the data files for the current data set are restored, as defined above. Particularly, the grading variables are changed to equal 1 and the repeat flag variables are reset to Off. It should be appreciated that in other various exemplary embodiments, the user can select that only the current data file or select data files are to be restored when activating the restore function.

The process proceeds to step S910, wherein a restore confirmation is outputted to the user. It is preferred that the output of the confirmation be displayed to the user and further that the prompt be displayed for a predefined duration, such as but not limited to 10 seconds. The confirmation can be displayed in such a way but is not limited to a question, such as “ALL RESTORED”, displayed on the digital display panel 110, shown in FIG. 3, for example.

The process ends at step S914.

In the above described and illustrated way, a person can record and playback questions and answers in a quick and efficient way so that the person can memorize material and test himself on the material in the most efficient manner. While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

1. A method of aiding memorization, comprising the steps of:
acquiring at least one data set having data files, wherein each of the data files has a grading variable;
viewing and manipulating the data files, wherein the manipulating the data files includes changing the grading variable of at least one of the data files; and,
reviewing the data files, wherein the frequency that each data file is reviewed is based on the grading variable of each data file.

2. A method as recited in claim 1, wherein the data files are digital data files.

3. A method as recited in claim 1, wherein the data files are audio data files.

4. A method as recited in claim 1, wherein each of the data files includes a data header having a repeat flag variable and a data file number and the grading variable is located in the data header.

5. A method as recited in claim 1, wherein the grading variable is a value equal to one of 1, 2 and 3.

6. A method as recited in claim 1, wherein the viewing of data files is executed by a handheld device.

7. A method as recited in claim 1, wherein the viewing of data files is executed by a computer.

8. A method as recited in claim 1, wherein the step of viewing the data files is based on the grading variable of the data files.

9. A method as recited in claim 1, further comprising acquiring a grading variable threshold, wherein when one of the data files has a grading variable equal to the grading variable threshold, the data file will not be viewed in the reviewing step.

10. A method as recited in claim 1, wherein the manipulating the data files is executed by a user activating a skip function.

11. A method as recited in claim 1, wherein the manipulating the data files is executed by a user by activating a change grading function.

12. A method as recited in claim 11, wherein the manipulating the data files includes changing the grading variable by an increment equal to the number of times the change grading function has been activated for the current data file.

13. A method as recited in claim 1, wherein the manipulating the data files is dynamically executed by a user during at least one of the viewing or reviewing steps.

14. A method as recited in claim 1, wherein the reviewing of the data files is repeatable by a user.

15. A method as recited in claim 1, wherein the reviewing of the data files is repeated based on the grading variable, wherein a grading variable of 1 is repeated every time, a grading variable of 2 is repeated every other time, and a grading variable of 3 is never repeated.

16. A method of operating a digital sound recorder comprising the steps of:
obtaining sound data files;
playing and grading at least one of the sound data files;
designating a repetition rate of the sound data files based on the grading; and,
replaying the sound data files based on the repetition rate.

17. A method as recited in claim 16, further wherein the replaying step includes skipping at least some of the sound data files based on the grading.

18. A method as recited in claim 16, wherein the repetition rate is inversely proportional to a grade level assigned in the grading step.

19. A method as recited in claim 16, wherein the importing of data files comes from a plurality of sources.

20. A method as recited in claim 16, wherein the grading steps occurs after a data file has been played in the playing step.

21. A method as recited in claim 16, further comprising displaying the grade variable for the current data file on a digital display.

22. A method as recited in claim 16, wherein at least some of the files will not be played during the playing step based on the grading of the data file assigned in the grading step.

23. A method as recited in claim 16, wherein the digital sound recorder has a play, a fast forward and rewind functions.

24. A method as recited in claim 23, wherein some of the data files will be skipped during the fast forward and rewind functions based on the grading of the data file assigned in the grading step.

25. A system of aiding memorization comprising:
a controller;
an output device;
a memory that stores data files each of which include have an associated grading variable;
a viewing circuit that under the control of the controller, reads the data file and outputs the data file to the output device at a frequency based on the grading variable of the data file being read; and,
a manipulating circuit that under the control of the controller, changes the grading variable of at least one of the data files, wherein the manipulation circuit is executed by a user.

26. A method comprising the steps of:
obtaining data files each of which include data and an associated grade variable;
viewing the data of the data files at a frequency based on the value of the grade variable of the data file being viewed; and,
manipulating the value of the grade variable of at least one of the data files.
